(19) United States
(12) Patent Application Publication
(10) Pub. No.: US 2022/0294000 A1
(43) Pub. Date: Sep. 15, 2022

(54) SHEET-BASED FRAMEWORK FOR HIGH-PERFORMANCE HYBRID QUASI-SOLID BATTERY

(71) Applicant: AGENCY FOR SCIENCE, TECHNOLOGY AND RESEARCH, Singapore (SG)

(72) Inventors: Jackie Y. Ying, Singapore (SG); Ayman A. Abdelhamid, Singapore (SG)

(21) Appl. No.: 17/619,188

(22) PCT Filed: Jun. 15, 2020
(86) PCT No.: PCT/SG2020/050333

§ 371 Date: Dec. 14, 2021

(30) Foreign Application Priority Data
Jun. 14, 2019 (SG) 10201905497R

(51) Int. Cl. H01M 10/056

(52) U.S. Cl. CPC H01M 10/056; H01M 2300/0082; H01M 2300/0071

(57) ABSTRACT

The present invention relates to a material comprising a garnet-type oxide in the form of a powder comprising a plurality of sheet structures, a hybrid quasi-solid electrolyte framework comprising the material, a hybrid quasi-solid electrolyte comprising the hybrid quasi-solid electrolyte framework, and an electrochemical cell comprising the hybrid quasi-solid electrolyte. The present invention also relates to the respective methods for preparing the material, hybrid quasi-solid electrolyte framework, hybrid quasi-solid electrolyte and electrochemical cell. The present invention also relates to the respective methods for preparing the material, hybrid quasi-solid electrolyte framework, hybrid quasi-solid electrolyte and electrochemical cell as described above.

### TECHNICAL FIELD

The present invention relates to a material comprising a garnet-type oxide in the form of a powder comprising a plurality of sheet structures, a hybrid quasi-solid electrolyte framework comprising the material, a hybrid quasi-solid electrolyte comprising the hybrid quasi-solid electrolyte framework, and an electrochemical cell comprising the hybrid quasi-solid electrolyte. The present invention also relates to the respective methods for preparing the material, hybrid quasi-solid electrolyte framework, hybrid quasi-solid electrolyte and electrochemical cell as described above.

### BACKGROUND ART

Lithium batteries are the most promising energy storage systems known. However, their current performance is not satisfactory for demanding applications, such as electric vehicles and grid storage. Safety is one of the main challenges facing the progress of lithium batteries, mainly due to the use of flammable, leakable and unstable liquid organic electrolytes, in addition to the chemical, and thermal and mechanical instability of Li metal anode and polymeric separators, respectively. High-performance all-solid-state battery system has become the ultimate goal of Li battery research due to its far superior safety profile. However, solid-state electrolytes (SSEs) have limited ionic conductivity, and poor electrode/electrolyte interface, which result in high resistance and low performance. Hybrid quasi-solid electrolytes (HQSEs) have recently emerged as a practical compromise for safer and high-performance Li batteries. They typically involve 2 components: a solid component and a liquid component. The hybrid quasi-solid system benefits from the advantages associated with the solid electrolyte, while mitigating its limitations using the liquid component.

Lithium-sulfur (Li—S) battery is one of the most attractive Li battery systems due to the abundance, low cost and high specific capacity (1675 mAh g⁻¹) of sulfur. However, Li—S system is still susceptible to the abovementioned safety issues, in addition to polysulfide (PS) shuttling that results in Li metal anode corrosion and active material loss. Solid-state systems have been studied for safer and PS shuttling-free Li—S batteries including, P₂S₅—Li₂S, Li_{3.25}Ge_{0.25}P_{0.75}S₄, and Li₁₀GeP₂S₁₂. However, these systems showed limited capacity and rate capability due to the limited ionic conductivity and high interfacial resistance of the SSEs. HQSEs using Li₁₊ₓAlₓTi₂₋ₓ (PO₄)₃, Li₁₊ₓYₓZr₂₋ₓ(PO₄)₃, Li_{1.5}Al_{0.5}Ge_{1.5}(PO₄)₃, pristine/doped Li₇La₃Zr₂O₁₂ (LLZO), and LiCoO₂, exhibited an improved performance, but they were still limited by the Li ion diffusion bottleneck introduced by the solid electrolyte pellet/layer utilized.

Reengineering Li—S hybrid quasi-solid system by controlling the solid component microstructure could help to overcome its current limitations. A study has shown that porous Li_{6.4}La₃Zr_{1.4}Ta_{0.6}O₁₂ can achieve remarkably good Li—S hybrid battery performance. However, the porous solid electrolyte used in this study was fabricated using typical solid-state synthesis, which is energy-demanding, requiring 2 calcination steps at 900° C. and 1200° C., labor-intensive, involving ball milling, calcination, mixing, pressing, and sintering, and time-consuming, requiring about 3 days. In addition, ceramic electrolyte pellets are known to be brittle and susceptible to cracking during processing, especially when they are porous.

There is therefore a need to provide a material that overcomes or at least ameliorates, one or more of the disadvantages described above.

### SUMMARY

In an aspect, there is provided a material comprising a garnet-type oxide in the form of a powder comprising a plurality of sheet structures.

Advantageously, the garnet-type oxide may be Li₇La₃Zr₂O₁₂(LLZO).

In another aspect, there is provided a method for forming the material as defined above, the method comprising the steps of: mixing a plurality of precursors for a garnet-type oxide in an aqueous solvent in the presence of a sugar to form a sol; and heating the sol.

Advantageously, a novel sol-gel methodology was developed for the synthesis of garnet-type oxide sheets, such as LLZO sheets, which were used as building blocks for the construction of a 3D garnet-type oxide or LLZO framework that was imbibed with liquid electrolyte, forming a high-performance HQSE. The garnet-type oxide or LLZO sheets were synthesized via a “cupcake” method, which is a novel one-step sol-gel process utilizing sucrose as a complexing and structure-directing agent to derive the garnet-type oxide or LLZO precursor with sheet-like morphology. The disclosed method has the following advantages:
Cost effectiveness: Unlike typical energy/time-consuming solid-state reaction methods that are used for garnet-type oxide or LLZO synthesis, the disclosed method may be facile, short and achieve the desired crystal structure and morphology at a relatively low temperature, making it cost effective. The reason why less energy and time may be expended using the disclosed method is because of its sol-gel nature, where the precursors are mixed at the molecular level, making it easier for the reactants to form the desired phase. This is unlike conventional solid-state reactions, where the reactions are started using solid precursors that require significantly longer time, greater labour and higher energy to achieve a reaction and the right crystal structure. In addition, the raw materials for garnet-type oxide or LLZO are not expensive. For example, a rough estimation for the raw materials for the synthesis of 100 g of LLZO sheets is approximately 376 SGD based on lab-scale non-bulk prices (for example from Sigma-Aldrich) and this could be much lower if bulk orders are used.
Scalability: The disclosed method may be scalable, where the precursors and structure directing agent are simply mixed together by dissolving them in deionized water. This is followed by a two-step reaction that takes place using a single program in a furnace. Around 0.5 g may be synthesized per batch, and there is no limitation to scaling the method up to produce larger batches.
Versatility of binders: The role of the binder is to bind the garnet-type oxide or LLZO sheets together forming the 3D HQSE solid framework. In addition to polytetrafluoro-ethylene (PTFE), other polymeric binders may be used, such as polyvinylidene fluoride, polyethylene oxide, sodium alginate, sodium carboxymethyl cellulose, polyacrylic acid, LA-132 (a copolymer comprising acrylamide, lithium carboxylate acrylonitrile), poly(acrylonitrile-methyl methacrylate) and styrene butadiene rubber/carboxy methyl cellulose.

In another aspect, there is provided a hybrid quasi-solid electrolyte framework comprising the material as defined above and a polymer.

In another aspect, there is provided a method for forming the hybrid quasi-solid electrolyte framework as defined above, the method comprising the step of mixing a material as defined above with a polymer to form a framework mixture.

In an aspect, there is provided a hybrid quasi-solid electrolyte comprising the hybrid quasi-solid electrolyte framework as defined above and an electrolyte.

Advantageously, the hybrid quasi-solid electrolyte may have a controlled microstructure and be used in Li hybrid quasi-solid batteries. The hybrid quasi-solid electrolyte may comprise a 3D garnet-type oxide such as a Li₇La₃Zr₂O₁₂ (LLZO) sheet-based solid framework imbibed with liquid electrolyte. Advantageously, Li₇La₃Zr₂O₁₂ (LLZO) may be chosen as the garnet-type oxide due to its high ionic conductivity (cubic phase), and good chemical and electrochemical stability.

Advantageously, the hybrid quasi-solid electrolyte may have high Li ion conductivity, excellent compatibility with a Li metal anode, impressive thermal stability, enhanced anodic stability, and excellent battery performance. A remarkable Li—S battery rate capability (about 515 and about 340 mAh/g at 1C and 2C, respectively) was achieved at a loading density of 1.5 mg cm⁻², which is among the best achieved by Li—S hybrid quasi-solid batteries. The 3D sheet-based framework was found to be critical for optimal battery performance. Moreover, the Li—S hybrid quasi-solid system showed an outstanding stability against extreme temperature conditions.

Advantageously, the hybrid quasi-solid garnet-type oxide or LLZO hybrid quasi-solid electrolyte circumvented the conventional electrolyte leakage problem, ensured adequate contact with electrodes, and enhanced stability against the Li metal anode. In addition, it allowed fast Li ion mobility and superior stability at high temperatures, as compared to commercial polymeric separators. These excellent properties were reflected in the Li—S hybrid quasi-solid battery performance, which was among the best reported so far, with high capacity, prolonged stability, excellent rate capability, and enhanced thermal stability.

In another aspect, there is provided a method for preparing the hybrid quasi-solid electrolyte as defined above, the method comprising the step of contacting the hybrid quasi-solid electrolyte framework as defined above with an electrolyte.

Advantageously, the garnet-type oxide sheets or LLZO sheets are processed into a non-rigid solid framework using polytetrafluoroethylene (PTFE). The solid framework may easily absorb a liquid electrolyte due to its porous nature. In addition, its non-rigid structure may allow very good contact with electrodes, and may prevent cracking during handling and battery assembly.

Advantageously, the garnet-type oxide precursor sheets or LLZO precursor sheets may be used as templates to produce crystallized cubic garnet-type oxide sheets or LLZO sheets when calcined in air. More advantageously, a non-rigid solid framework using garnet-type oxide sheets or LLZO sheets may be designed to be used as building blocks, while the polymer may be used as a binder. The sheet-based framework may allow efficient electrolyte infiltration within the solid electrolyte. The non-rigidity of the structure may eliminate the risk of cracking during handling and battery assembly.

In another aspect, there is provided an electrochemical cell comprising the hybrid quasi-solid electrolyte as defined above, a cathode and an anode.

In another aspect, there is provided a method of manufacturing an electrochemical cell as defined above, the method comprising the step of contacting the hybrid quasi-solid electrolyte as defined above with a cathode and an anode.

Advantageously, the new garnet-type oxide or LLZO hybrid quasi-solid electrolyte design may allow for operating Li batteries, including Li—S and Li-ion batteries, in a hybrid quasi-solid state, which is safer than the liquid state in conventional batteries.

More advantageously, garnet-type oxide or LLZO hybrid quasi-solid electrolyte may eliminate liquid electrolyte leakage, enhance thermal stability, and improve stability against Li dendrite-induced short circuits. In addition, the HQSE may mitigate polysulfide shuttling in Li—S battery, and improve anodic stability in Li-ion batteries with higher-voltage cathodes, such as LiCoO₂. The garnet-type oxide or LLZO hybrid quasi-solid electrolyte may be useful in a Li-ion battery, demonstrating better performance, as compared to a commercial Celgard membrane. This may be attributed to its higher anodic stability.

In another aspect, there is provided the use of the hybrid quasi-solid electrolyte framework as defined above as a separator in an electrochemical cell.

The new hybrid quasi-solid electrolyte design may be applied to uses involving other solid electrolytes, and other Li battery chemistries. Thus, it is a very promising approach for achieving batteries with high performance and enhanced safety.

The present disclosure therefore advantageously demonstrates the significance of the novel garnet-type oxide or LLZO sheet morphology, and the high potential of the disclosed 3D sheet-based structure for use as a HQSE framework in different types of Li batteries.

### Definitions

The following words and terms used herein shall have the meaning indicated:

The term “garnet-type oxide” refers to metal oxides with the general formula A₃B₂(XO₄)₃, wherein A, B and X are metals whose A, B, X are eight, six and four oxygen coordinated cation sites, respectively, including but not limited to (A=Ca, Mg, Y, La or rare earth; B═Zr, Al, Fe, Ga, Ge, Mn, Ni or V; X═Li, Si, Ge, Al), including Li garnets and stuffed Li garnets that comprise Li in the X position, such as Li₅La₃M₂O₁₂ (M=Nb or Ta), Li₆ALa₂M₂O₁₂ (A=Ca, Sr or Ba; M=Nb or Ta) and Li₇La₃M₂O₁₂ (M=Zr and/or Nb) and its Ta and Ga doped derivatives. When the molar ratio of X is greater than 3, the garnet-type oxide is referred to as “stuffed Li garnets”, for example as in Li₇La₃M₂O₁₂.

As used herein, the term “doping” or “doped” refers to the concept of replacing an element in the parent material's lattice such that the crystal structure of the parent material is unchanged. The term “dopant” should be construed accordingly, as the element used to dope the parent material.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF OPTIONAL EMBODIMENTS

There is provided a material comprising a garnet-type oxide in the form of a powder comprising a plurality of sheet structures.

The material may comprise a solid mixture of at least lithium and oxygen and optionally an element selected from the group consisting of magnesium, aluminium, silicon, calcium, scandium, vanadium, manganese, iron, nickel, gallium, germanium, strontium, yttrium, zirconium, niobium, barium, tantalum, lanthanum, cerium, neodymium, samarium, europium, gadolinium, terbium and any mixture thereof.

The material may be further doped with one or more elements selected from the group consisting of hydrogen, beryllium, boron, carbon, sodium, phosphorous, sulfur, chlorine, potassium, titanium, chromium, cobalt, copper, zinc, arsenic, selenium, bromine, rubidium, molybdenum, technetium, ruthenium, rhodium, palladium, silver, cadmium, indium, tin, antimony, tellurium, iodine, cesium, hafnium, tungsten, iridium, platinum, gold, mercury, thallium, lead, bismuth, and any mixture thereof.

The garnet-type metal oxide may at least comprise lithium and oxygen.

The garnet-type metal oxide may be selected from the group consisting of but not limited to Li₇La₃Zr₂O₁₂ (LLZO), Li₅La₃Nb₂O₁₂, Li₅La₃Ta₂O₁₂, Li₆BaLa₂Ta₂O₁₂, or Li_{6.5}La₃₋ₓBaₓZr_{1.5-x}Ta_{0.5+x}O₁₂ (LLBZT), Li₇₋ₓLa₃(Zr₂₋ₓ, Nbₓ)O₁₂ (X=0-2), Li₅La₃Bi₂O₁₂, Li₅La₃Nb₂₋ₓVₓO₁₂ (x=0.05, 0.1), Li₅La₃Nb₂₋ₓVₓO₁₂ (x=0.15, 0.2, 0.25), Li₅La₃Nb₂₋ₓVₓO₁₂ (x=0.2, 0.25), Li₆CaSm₂Ta₂O₁₂, Li_{6.4}La₃Zr_{1.4}Ta_{0.6}O₁₂—MgO, Li_{6.45}Ca_{0.05}La_{2.95}Ta_{0.6}—Zr_{1.4}O₁₂, Li_{6.4}La₃Zr_{1.4}Ta_{0.6}O₁₂, Li₇La_{2.75}Ca_{0.25}Zr_{1.75}—Nb_{0.25}O₁₂, Li_{6.4}La₃Zr_{1.4}Ta_{0.6}O₁₂, Li_{6.20}Ga_{0.30}La_{2.95}Rb_{0.05}Zr₂O₁₂, Li_{6.85}La_{2.9}Ca_{0.1}Zr_{1.75}Nb_{0.25}O₁₂, Li₇La₃Zr₂O₁₂-0.3B₂O₃, Li_{6.25}Al_{0.25}La₃Zr₂O₁₂, Li_{6.75}La₃Zr_{1.75}Nb_{0.25}O₁₂, Li_{6.8}(La_{2.95},Ca_{0.05})(Zr_{1.75},Nb_{0.25})O₁₂, Li₇La₃Zr₂O₁₂ (1.7 wt % Al, 0.1 wt % Si), Li_{6.7}La₃Zr_{1.75}Nb_{0.25}O₁₂, Li_{6.55}La₃Zr₂Ga_{0.15-0.3}O₁₂, Li₇La₃Zr₂O₁₂/0-1.5% Al, Li₆BaLa₂Ta₂O₁₂, Li_{6.7}La₃Zr_{1.7}Ta_{0.3}O₁₂, Li_{6.75}La₃Zr_{1.875}Te_{0.125}O₁₂, Li_{6.6}La₃Zr_{1.6}Sb_{0.4}O₁₂, Li_{6.55}La₃Hf_{1.55}Ta_{0.45}O₁₃, Li_{6.5} La₃Nb_{1.25}Y_{0.75}O₁₂, Li_{6.5} La₃Zr_{1.75}Te_{0.25}O₁₂, Li_{6.4}La₃Zr_{1.7}W_{0.3}O₁₂, Li_{6.4}La₃Zr_{1.4}Ta_{0.6}O₁₂, Li_{6.25}La₃Zr₂Ga_{0.25}O₁₂, Li_{6.15}La₃Zr_{1.75}Ta_{0.25}Ga_{0.2}O₁₂, Li_{6.15}La₃Zr_{1.75}Ta_{0.25}Al_{0.2}O₁₂, Li₆La₃Zr_{1.5}W_{0.5}O₁₂, Li₆La₃ZrTaO₁₂, Li₆BaLa₂Ta₂O₁₂, Li₆CaLa₂Ta₂O₁₂, Li₆MgLa₂Ta₂O₁₂, Li_{5.5}La₃Zr₂Ga_{0.5}O₁₂, Li_{5.5}La_{2.75}K_{0.25}Nb₂O₁₂, Li_{5.5}La₃Nb_{1.75}In_{0.25}O₁₂, Li₅La₃Nb_{2_x}YₓO_{12_δ}, Li₅La₃Sb₂O₁₂, Li₅₊ₓBaLa₂Ta₂O_{11.5+0.5x}, Li₃₊ₓNd₃Te_{2_x}SbₓO₁₂, Li_{7.06}La₃Zr_{1.94}Y_{0.06}O₁₂, Li₇La₃Hf₂O₁₃, Li₇La₃Zr₂O₁₂ (CO₂ doped), Li_{6.5}La_{2.5}Ba_{0.5}ZrTaO₁₂ and Li₆SrLa₂Bi₂O₁₂.

The material may comprise a solid mixture of lithium, lanthanum, zirconium and oxygen.

The material may further comprise an element selected from the group consisting of aluminium, niobium, tantalum and gallium.

The garnet-type metal oxide may have the following formula: LiₓLa_{y}Zr_{z}O₁₂, wherein: 4<x<9, 4<x<5, 4<x<6, 4<x<7, 4<x, 8, 5<x<6, 5<x<7, 5<x<8, 5<x<9, 6<x<7, 6<x<8, 6<x<9, 7<x<8, 7<x<9 or 8<x<9, 2<y<6, 2<y<3, 2<y<4, 2<y<5, 3<y<4, 3<y<5, 3<y<6, 4<y<5, 4<y<6 or 5<y<6 and 1<z<3, 1<z<2, or 2<z<3.

The lithium:lanthanum:zirconium:oxygen ratio may be 7:3:2:12. The material may comprise Li₇La₃Zr₂O₁₂ (LLZO).

The lithium:lanthanum:zirconium:oxygen ratio may change depending on the presence of other metals selected from the group consisting of aluminium, niobium, tantalum and gallium.

The material may be a powder.

The solid mixture may be a powder, and not any kind of liquid or coating.

The sheet structures may have a lateral dimension of greater than 1 μm, preferably greater than 10 μm.

Larger lateral dimensions may allow the sheet structures to form a framework with large pores, which may facilitate free flow of Li ions.

The sheet structures may have a thickness in the range of about 100 nm to about 250 nm, about 100 nm to about 150 nm, about 100 nm to about 200 nm, about 150 nm to about 200 nm, about 150 nm to about 250 nm and about 200 nm to about 250 nm.

The sheet structures may be interconnected with each other. Individual sheet structures within the powder may therefore be attached or connected to each other.

The sheet structures may be crystalline.

There is also provided a method for forming the material as defined above, the method comprising the steps of: mixing a plurality of precursors of a garnet-type oxide in an aqueous solvent in the presence of a sugar to form a sol.

The method may be a sol-gel method.

The precursors are selected from at least a lithium salt and oxygen or a compound containing oxygen and optionally a compound comprising an element selected from the group consisting of magnesium, aluminium, silicon, calcium, scandium, vanadium, manganese, iron, nickel, gallium, germanium, strontium, yttrium, zirconium, niobium, barium, tantalum, lanthanum, cerium, neodymium, samarium, europium, gadolinium, terbium and any mixture thereof, wherein the compound may preferably be a salt of the element as valency allows.

The method may further comprise the step of incorporating a dopant into the material, the dopant being one or more elements selected from the group consisting of hydrogen, beryllium, boron, carbon, sodium, phosphorous, sulfur, chlorine, potassium, titanium, chromium, cobalt, copper, zinc, arsenic, selenium, bromine, rubidium, molybdenum, technetium, ruthenium, rhodium, palladium, silver, cadmium, indium, tin, antimony, tellurium, iodine, cesium, hafnium, tungsten, iridium, platinum, gold, mercury, thallium, lead, bismuth, and any mixture thereof.

The salt may be a fluoride salt, chloride salt, bromide salt, iodide salt, sulfate salt, sulfide salt, phosphide salt, oxide salt, carbonate salt, chlorate salt, chromate salt, dichromate salt, nitrate salt, nitrite salt, nitride salt, perchlorate salt, permanganate salt, and any mixture thereof. The salt may be a nitrate salt.

The salt may be soluble in the aqueous solvent.

The heating of the sol may result in the polymerization and thermal decomposition of the sugar, as well as crystallization of the garnet-type oxide.

The mixing step may comprise mixing a lithium salt, a lanthanum salt, a zirconium salt with the sugar.

The garnet-type oxide may be synthesized as sheets via a “cupcake” method, which may involve a one-step sol-gel process with a sugar such as sucrose as a complexing and structure-directing agent. This is the first disclosure of the synthesis of garnet-type oxide or LLZO sheets by this method, and also the first sol-gel method disclosed for generating sheet morphology using sucrose as a structure-directing agent.

The “cupcake” method may allow large-scale synthesis of cubic LLZO with controlled sheet morphology at a moderate temperature, as low as 850° C., and in a short duration of time of about 17 hours. A sol-gel approach was adopted because it may enable mixing of the precursors at the molecular level, leading to lower temperature synthesis, smaller grain size, and controlled morphology. Although sol-gel synthesis of LLZO has been reported previously, it has typically been employed to produce fine powder at less extreme conditions, as compared to solid-state synthesis, and not for synthesizing LLZO with a controlled morphology. In addition, sucrose has not previously been employed in LLZO synthesis, nor has it been reported for inorganic sheet formation.

The lithium salt may be LiNO₃, the lanthanum salt may be La(NO₃)₃.6H₂O, and the zirconium salt may be ZrO(NO₃)₂.xH₂O, wherein x may be 0 or an integer in the range of 1 to 10.

The aqueous solvent may be deionized water.

The sugar may be a monosaccharide, a disaccharide, an oligosaccharide or any mixture thereof.

The sugar may be selected from the group consisting of glucose, fructose, galactose, sucrose, lactose, maltose, glycans, carbohydrates, starch and cellulose.

The sugar may be sucrose.

The sol gel may have a pH in the range of about 1 to about 2, about 1 to about 1.25, about 1 to about 1.5, about 1 to about 1.75, about 1.25 to about 1.5, about 1.25 to about 1.75, about 1.25 to about 2, about 1.5 to about 1.75, about 1.5 to about 2 or about 1.75 to about 2. The sol gel may have a pH of about 1.5.

The heating step may comprise a first heating step and a second heating step.

The first heating step may be performed at a temperature in the range of about 150° C. to about 500° C., about 150° C. to about 175° C., about 175° C. to about 200° C., about 200° C. to about 225° C., about 225° C. to about 250° C., about 250° C. to about 275° C., about 275° C. to about 300° C., about 300° C. to about 325° C., about 325° C. to about 350° C., about 350° C. to about 375° C., about 375° C. to about 400° C., about 400° C. to about 425° C., about 425° C. to about 450° C., about 450° C. to about 475° C., about 475° C. to about 500° C., about 150° C. to about 250° C., about 150° C. to about 350° C., about 250° C. to about 350° C., about 250° C. to about 500° C., or about 350° C. to about 500° C.

The first heating step may be performed at a temperature of about 250° C. The first heating step may be performed for a duration in the range of about 0.5 hours to about 5 hours or more, about 0.5 hour to about 1 hour, about 1 hours to about 2 hours, about 2 hours to about 3 hours, about 3 hours to about 4 hours about 4 hours to about 5 hours, 0.5 hours to about 2 hours, about 0.5 hours to about 3 hours, about 0.5 hours to about 4 hours, about 2 hours to about 4 hours, about 2 hours to about 5 hours, or about 3 hours to about 5 hours, or for more than 5 hours. The first heating step may be performed for a duration of about 3 hours.

The second heating step may performed at a temperature in the range of about 600° C. to about 1500° C., about 600° C. to about 700° C., or about 700° C. to about 800° C., or about 800° C. to about 900° C., or about 900° C. to about 1000° C., or about 1000° C. to about 1100° C., or about 1100° C. to about 1200° C., or about 1200° C. to about 1300° C., or about 1300° C. to about 1400° C., about 1400° C. to about 1500° C., about 600° C. to about 800° C., about 600° C. to about 1000° C., about 600° C. to about 1200° C., about 800° C. to about 1000° C., about 800° C. to about 1200° C., about 800° C. to about 1500° C., about 1000° C. to about 1200° C., about 1000° C. to about 1500° C. or about 1200° C. to about 1500° C.

The second heating step may be performed at a temperature of about 850° C. The second heating step may be performed for a duration in the range of about 30 minutes to about 10 hours or more, about 30 minutes to about 1 hour, about 1 hour to 2 hours, about 2 hours to about 3 hours, about 3 hours to about 4 hours, about 4 hours to about 5 hours, about 5 hours to about 6 hours, about 6 hours to about 7 hours, about 7 hours to about 8 hours, about 8 hours to about 9 hours, about 9 hours to about 10 hours, about 30 minutes to about 2 hours, about 30 minutes to about 4 hours, about 30 minutes to about 6 hours, about 30 minutes to about 8 hours, about 2 hours to about 4 hours, about 2 hours to about 6 hours, about 2 hours to about 8 hours, about 2 hours to about 10 hours, about 4 hours to about 6 hours, about 4 hours to about 8 hours, about 4 hours to about 10 hours, about 6 hours to about 8 hours, about 6 hours to about 10 hours, or about 8 hours to about 10 hours, or more than 10 hours. The second heating step may crystallize the garnet-type oxide and oxidize the carbon in the sugar. The second heating step may be performed for a duration of about 1 hour.

The method may further comprise the step of breaking up the heated sol to obtain a powder.

After the second heating step, a foamy “cupcake” made up of the sheet structures is obtained. Gently breaking the “cupcake” provides the powder comprising a plurality of sheet structures.

There is also provided a material formed by the method as defined above.

There is also provided a hybrid quasi-solid electrolyte framework comprising the material as defined above and a polymer.

The garnet-type oxide or LLZO sheets may be processed into a non-rigid solid framework using a polymer such as polytetrafluoroethylene (PTFE). The solid framework may easily absorb a liquid electrolyte due to its porous nature. In addition, its non-rigid structure may allow very good contact with electrodes, and prevent cracking during handling and battery assembly.

The polymer may be selected from the group consisting of polytetrafluoroethylene (PTFE), polyvinylidene fluoride, polyethylene oxide, sodium alginate, sodium carboxymethyl cellulose, polyacrylic acid, poly(acrylonitrile-methyl methacrylate), styrene butadiene rubber/carboxy methyl cellulose (SBR/CMC), a copolymer comprising acrylamide, lithium carboxylate and acrylonitrile, and any mixture thereof.

The ratio between the hybrid quasi-solid electrolyte framework:polymer may be in the range of about 20:1 to about 2:1, about 20:1 to about 5:1, about 20:1 to about 7:1, about 20:1 to about 9:1, about 20:1 to about 12:1, about 20:1 to about 15:1, about 15:1 to about 2:1, about 15:1 to about 5:1, about 15:1 to about 7:1, about 15:1 to about 9:1, about 15:1 to about 12:1, about 15:1 to about 20:1, about 12:1 to about 2:1, about 12:1 to about 5:1, about 12:1 to about 7:1, about 12:1 to about 9:1, about 12:1 to about 20:1, about 9:1 to about 2:1, about 9:1 to about 5:1, about 9:1 to about 7:1, about 9:1 to about 20:1, about 7:1 to about 2:1, about 7:1 to about 5:1, about 7:1 to about 20:1, about 5:1 to about 2:1, about 5:1 to about 20:1, or about 3:1 to about 20:1, preferably from about 19:1 to about 2.33:1, or about 9:1 to about 2.33:1.

The polymer may be present at an amount in the range of 5% to 30% by weight of the quasi-solid electrolyte framework. The polymer may be present at an amount in the range of 5% to 30%, 5% to 10%, 5% to 20%, 10% to 20%, 10% to 30%, or 20% to 30% by weight of the quasi-solid electrolyte framework.

The framework may be in the form of a disc having a diameter in the range of about 10 mm to about 20 mm or more than 20 mm, about 10 mm to about 11 mm, about 11 mm to about 12 mm, about 12 mm to about 13 mm, about 13 mm to about 14 mm, about 14 mm to about 15 mm, about 15 mm to about 16 mm, about 16 mm to about 17 mm, about 17 mm to about 18 mm, about 18 mm to about 19 mm, about 19 mm to about 20 mm, about 10 mm to about 12 mm, about 10 mm to about 14 mm, about 10 mm to about 16 mm, about 10 mm to about 18 mm, about 12 mm to about 14 mm, about 12 mm to about 14 mm, about 12 mm to about 16 mm, about 12 mm to about 18 mm, about 12 mm to about 20 mm, about 14 mm to about 16 mm, about 14 mm to about 18 mm, about 14 mm to about 20 mm, about 16 mm to about 18 mm, about 16 mm to about 18 mm or about 18 mm to about 20 mm or more than 20 mm. The framework may be in the form of a disc having a diameter of about 16.2 mm.

The thickness of the disc may be in the range of about 50 μm to about 500 μm or more than 500 μm, about 50 μm to about 100 μm, about 100 μm to about 200 μm, about 200 μm to about 300 μm, about 300 μm to about 400 μm, about 400 μm to about 500 μm, about 50 μm to about 150 μm, about 50 μm to about 250 μm, about 50 μm to about 350 μm, about 150 μm to about 250 μm, about 150 μm to about 350 μm, about 150 μm to about 500 μm, about 250 μm to about 350 μm, about 250 μm to about 500 μm or about 350 μm to about 500 μm or more than 500 μm. The thickness of the disc may be about 250 μm.

The diameter and thickness of the disc may be adjusted according to battery size. The anode, cathode and other cell parts may be of any thickness and diameter depending on battery size.

The framework may be porous. The pores may have a size in the range of 0.1 μm to about 10 μm, about 0.1 μm to about 0.2 μm, about 0.1 μm to about 0.2 μm, about 0.1 μm to about 0.5 μm, about 0.1 μm to about 1 μm, about 0.1 μm to about 2 μm, about 0.1 μm to about 5 μm, about 0.2 μm to about 0.5 μm, about 0.2 μm to about 1 μm, about 0.2 μm to about 2 μm, about 0.2 μm to about 5 μm, about 0.2 μm to about 10 μm, about 0.5 μm to about 1 μm, about 0.5 μm to about 2 μm, about 0.5 μm to about 5 μm, about 0.5 μm to about 10 μm, about 1 μm to about 2 μm, about 1 μm to about 5 μm, about 1 μm to about 10 μm, about 2 μm to about 5 μm, about 2 μm to about 10 μm, about 5 μm to about 10 μm.

There is also provided a method for forming the hybrid quasi-solid electrolyte framework as defined above, the method comprising the step of mixing a material as defined above with a polymer to form a framework mixture.

The method may comprise the step of rolling the framework mixture into a membrane having a thickness in the range of about 50 μm to about 500 μm or more than 500 μm, about 50 μm to about 100 μm, about 100 μm to about 200 μm, about 200 μm to about 300 μm, about 300 μm to about 400 μm, about 400 μm to about 500 μm, about 50 μm to about 150 μm, about 50 μm to about 250 μm, about 50 μm to about 350 μm, about 150 μm to about 250 μm, about 150 μm to about 350 μm, about 150 μm to about 500 μm, about 250 μm to about 350 μm, about 250 μm to about 500 μm or about 350 μm to about 500 μm or more than 500 μm. The thickness of the disc may be about 250 μm.

The method may comprise the step of cutting the membrane into a disc having a diameter in the range of about 10 mm to about 20 mm or more than 20 mm, about 10 mm to about 11 mm, about 11 mm to about 12 mm, about 12 mm to about 13 mm, about 13 mm to about 14 mm, about 14 mm to about 15 mm, about 15 mm to about 16 mm, about 16 mm to about 17 mm, about 17 mm to about 18 mm, about 18 mm to about 19 mm, about 19 mm to about 20 mm, about 10 mm to about 12 mm, about 10 mm to about 14 mm, about 10 mm to about 16 mm, about 10 mm to about 18 mm, about 12 mm to about 14 mm, about 12 mm to about 14 mm, about 12 mm to about 16 mm, about 12 mm to about 18 mm, about 12 mm to about 20 mm, about 14 mm to about 16 mm, about 14 mm to about 18 mm, about 14 mm to about 20 mm, about 16 mm to about 18 mm, about 16 mm to about 18 mm or about 18 mm to about 20 mm or more than 20 mm. The framework may be in the form of a disc having a diameter of about 16.2 mm.

The method may comprise the step of drying the framework mixture at a temperature in the range of about 50° C. to about 100° C., about 50° C. to about 60° C., about 60° C. to about 70° C., about 70° C. to about 80° C., about 80° C. to about 90° C., about 90° C. to about 100° C., about 50° C. to about 70° C., about 50° C. to about 90° C., about 70° C. to about 90° C., or about 70° C. to about 100° C., about 90° C. to about 100° C. The method may comprise the step of drying the framework mixture at a temperature of about 60° C.

There is also provided a hybrid quasi-solid electrolyte comprising the hybrid quasi-solid electrolyte framework as defined above and an electrolyte dissolved in an electrolyte solvent.

The electrolyte may be present in the electrolyte solvent at a concentration in the range of about 0.25 M to about 10 M, about 0.25 M to about 0.5 M, about 0.25 M to about 1 M, about 0.25 M to about 2 M, about 0.25 M to about 5 M, about 0.5 M to about 1 M, about 0.5 M to about 2 M, about 0.5 M to about 5 M, about 0.5 M to about 10M, about 1 M to about 2 M, about 1 M to about 5 M, about 2 M to about 10 M, or about 5 M to about 10M.

The hybrid quasi-solid electrolyte may comprise liquid-imbibed 3D garnet-type oxide or Li₇La₃Zr₂O₁₂ sheet-based framework and may overcome typical hybrid quasi-solid electrolyte limitations, achieving a high-performance Li—S battery with a very good safety profile.

The disclosed hybrid quasi-solid electrolyte design may have controlled microstructure for use in a Li—S hybrid quasi-solid battery. The new hybrid quasi-solid electrolyte may consists of a 3D garnet-type oxide or LLZO sheet-based solid framework imbibed with liquid electrolyte, bis(trifluoromethane)sulfonimide lithium compound (LiTFSI) in a mixture of dimethoxyethane (DME) and 1,3-dioxolane (DOL). LLZO may be chosen as the solid framework due to its high ionic conductivity (cubic phase), and good chemical and electrochemical stability.

The electrolyte may comprise a lithium compound.

The electrolyte may be a lithium compound selected from the group consisting of but not limited to LiPF₆, LiClO₄, LiAsF₆, LiBF₄, lithium trifluoromethanesulfonate and lithium bis(trifluoromethanesulfonyl)imide (LiTFSI).

The electrolyte solvent may be selected from the group consisting of but not limited to ether, carbonate and any mixture thereof, preferably selected from the group consisting of but not limited to dimethoxyethane (DME), 1,3-dioxolane (DOL), propylene carbonate, ethylene carbonate, dimethyl carbonate and diethyl carbonate.

The electrolyte solvent may be a mixture of DME and DOL, or a mixture of ethylene carbonate and diethylcarbonate

The electrolyte may comprise lithium bis(trifluoromethanesulfonyl)imide (LiTFSI) or LiPF₆ at a concentration in the range of about 0.25 M to about 10M, about 0.25 M to about 0.5 M, about 0.5 M to about 1 M, about 1 M to about 2 M, about 2 M to about 3 M, about 3 M to about 4 M, about 4 M to about 5 M, about 5 M to about 6 M, about 6 M to about 7M, about 7 M to about 8 M, about 8 M to about 9 M, about 9 M to about 10 M, about 0.25 M to about 0.5 M, about 0.25 M to about 1 M, about 0.25 M to about 2 M, about 0.25 M to about 5 M, about 0.5 M to about 1 M, about 0.5 M to about 2 M, about 0.5 M to about 5 M, about 0.5 M to about 10M, about 1 M to about 2 M, about 1 M to about 5 M, about 2 M to about 10 M, or about 5 M to about 10M.

The electrolyte may further comprise an electrolyte additive. The electrolyte additive may be LiNO₃.

The electrolyte additive may be present at a concentration in the range of about 1 wt % to about 3 wt %, about 1 wt % to about 2 wt % or about 2 wt % to about 3 wt %.

The electrolyte may comprise a mixture of dimethoxyethane (DME) and 1,3-dioxolane (DOL) at a ratio in the range of about 0.25:1 to about 1:0.25, about 0.25:1 to about 1:0.5, about 0.25:1 to about 1:0.75, about 0.25:1 to about 1:1, about 0.5:1 to about 1:0.25, about 0.5:1 to about 1:0.5, about 0.5:1 to about 1:0.75, about 0.5:1 to about 1:1, about 0.75:1 to about 1:0.25, about 0.75:1 to about 1:0.5, about 0.75:1 to about 1:0.75, about 0.75:1 to about 1:1, about 1:1 to about 1:0.25, about 1:1 to about 1:0.5, about 1:1 to about 1:0.75 by volume.

The electrolyte may comprise a mixture of ethylene carbonate and diethylcarbonate at a ratio in the range of about 0.25:1 to about 1:0.25, about 0.25:1 to about 1:0.5, about 0.25:1 to about 1:0.75, about 0.25:1 to about 1:1, about 0.5:1 to about 1:0.25, about 0.5:1 to about 1:0.5, about 0.5:1 to about 1:0.75, about 0.5:1 to about 1:1, about 0.75:1 to about 1:0.25, about 0.75:1 to about 1:0.5, about 0.75:1 to about 1:0.75, about 0.75:1 to about 1:1, about 1:1 to about 1:0.25, about 1:1 to about 1:0.5, about 1:1 to about 1:0.75 by volume.

The electrolyte may be a mixture of 1 M LiTFSI in DME:DOL (1:1 by volume) and 2 wt % LiNO₃, or a mixture of 1 M LiPF₆ in ethylene carbonate:diethylcarbonate (1:1 by volume).

There is also provided a method for preparing the hybrid quasi-solid electrolyte as defined above, the method comprising the step of contacting the hybrid quasi-solid electrolyte framework as defined above with an electrolyte.

There is also provided an electrochemical cell comprising the hybrid quasi-solid electrolyte as defined above, a cathode and an anode.

The hybrid quasi-solid electrolyte may demonstrate high Li ion conductivity, excellent compatibility with Li metal anode, impressive thermal stability, and superior Li—S battery performance.

A remarkable rate capability of about 515 and about 340 mAh/g at 1 and 2C, respectively, may be achieved at a loading density of 1.5 mg cm⁻², which is among the highest achieved by Li—S hybrid quasi-solid batteries. The 3D sheet-based framework may be critical for optimal battery performance. Moreover, the Li—S hybrid quasi-solid system may have outstanding stability under extreme temperatures.

The cathode may be selected from the group consisting of a sulfur cathode,sulfur.carbon/ceramic cathode and metal cathode. The cathode may be selected from the group consisting of but not limited to a graphene/sulfur cathode, a carbon nanotube/sulfur cathode, sulfur-graphene oxide nanocomposite cathode, porous TiO₂-encapsulated sulfur nanoparticles. The cathode may be a Li-ion battery cathode. The Li-ion battery cathode may be selected from the group consisting of but not limited to LiCoO₂, lithium nickel manganese cobalt oxide, lithium nickel aluminium oxide and lithium iron phosphate.

The cathode may be selected from a graphene/sulfur cathode or a LiCoO₂ cathode.

The cathode may be a graphene/sulfur cathode and in which case, the hybrid quasi-solid electrolyte may comprise 1 M LiTFSI in DME:DOL (1:1 by volume) and 2 wt % LiNO₃, at 5 μL/mg to 50 μL/mg sulfur.

The cathode may be a LiCoO₂ cathode, in which case the hybrid quasi-solid electrolyte may comprise 1 M LiPF₆ in ethylene carbonate:diethylcarbonate (1:1 by volume) at 5 μL/mg to 50 μL/mg LiCoO₂.

The cathode may be present in an amount in the range of about 5 μL/mg to about 50 μL/mg, about 5 μL/mg to about 10 μL/mg, about 5 μL/mg to about 20 μL/mg, about 10 μL/mg to about 20 μL/mg, about 10 μL/mg to about 50 μL/mg, or about 20 μL/mg to about 50 μL/mg.

The anode may comprise a material selected from the group consisting of lithium metal, graphite, hard carbon, silicon, tin, silicon/C composite, tin/C composite and any mixture thereof.

The anode may comprise lithium metal or lithium metal alloys.

The anode may be a lithium metal anode.

There is also provided a method of manufacturing an electrochemical cell as defined above, the method comprising the step of contacting the hybrid quasi-solid electrolyte as defined above with a cathode and an anode.

There is also provided the use of the hybrid quasi-solid electrolyte framework as defined above as a separator in an electrochemical cell.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a set of images showing a) photographs and b) schematic of the synthesis of LLZO sheets. a) and b) both show the dissolution of metal nitrates and sucrose forming a clear solution, which was then heated at 250° C. to undergo polymerization, followed by foaming due to thermal decomposition. Upon subsequent heating at 850° C., the organic component was decomposed and oxidized as CO₂ and H₂O gases, while the homogeneously distributed metal ions reacted and crystallized into LLZO.

FIG. 2 is a set of images showing a) to c) SEM images and d) TEM images of LLZO sheets. Scale bar for a) and b) is 10 μm, c) is 1 μm and d) is 5 nm.

FIG. 3 is a set of FESEM images of LLZO a) without and b) with sucrose use during synthesis. Scale bar is 10 μm.

FIG. 4 is an FESEM image of LLZO sheets showing intersheet connecting junctions (indicated by circles). Scale bar is 1 μm.

FIG. 5 is a set of images showing a) a graph showing XRD patterns of LLZO precursor sheets and LLZO sheets and, b) scanning TEM image, and c) to e) EDX elemental maps of LLZO sheets.

FIG. 6 is a set of images showing a) schematic depciting LLZO HQSE preparation, whereby interconnected LLZO sheets were bound together using polytetrafluoro-ethylene (PTFE), and then processed into discs, which were imbibed with the liquid electrolyte, b) to d) FESEM images and (inset in b) photograph of LLZO HQSE solid framework, and e) electrolyte imbibition test (right is Celgard 2500 membrane and left is inventive LLZO framework) and f) thermal stability (right is Celgard 2500 membrane and left is inventive LLZO framework). Liquid electrolyte volume was 50 μL for the electrolyte imbibition and thermal stability tests. Scale bar for b) and d) is 100 μm and c) is 10 μm.

FIG. 7 is a set of images showing a) Nyquits plots of LLZO HQSE, b) ionic conductivity of LLZO HQSE (left in FIG. 6e, 6f) and Celgard (right in 6e, 6f), and Li symmetric cell cycling of c) LLZO HQSE and d) Celgard. Liquid electrolyte volume was 30 μL for ionic conductivity and Li symmetric cell cycling tests.

FIG. 8 is a set of photographs of LLZO HQSE: a) as prepared, and b) after EIS testing and coin cell disassembly.

FIG. 9 is a set of graphs showing the linear sweep voltammtery of 30 μL of liquid electrolyte-infused LLZO HQSE and Celgard at 1 mV s⁻¹ using a) LiTFSI in DME/DOL and b) LiPF₆ in ethylene carbonate/diethyl carbonate electrolyte, as well as c) cycling stability and d) coulombic efficiency of LiCoO₂ using LLZO HQSE and Celgard membrane.

FIG. 10 is a schematic depicting G/S cathode preparation, whereby a¹), a²) are FESEM images, a³), a⁴) are EDX elemntal maps of G/S composite, a⁵) is a photograph and a⁶) is a FESEM image of G/S cathode. Scale bar for a¹) and a⁶) is 1 μm, a²) is 2.5 μm.

FIG. 11 is a set of graphs showing a) CV curves and b) Nyquist plots of Li—S hybrid quasi-solid battery.

FIG. 12 is a set of graphs showing a), b) Discharge-charge profiles at 0.1C and c), d) cycling performance at 0.1C and 0.2C, of a), c), d) LLZO HQSE and b) to d) Celgard.

FIG. 13 is a set of graphs showing the capacity loss over cycling of Li—S battery at 0.1C using liquid electrolyte-infused a) LLZO HQSE and b) Celgard.

FIG. 14 is a set of graphs showing a), b) Discharge-charge profiles and c), d) capacity loss over cycling of Li—S battery at 0.5C using electrolyte-infused a), c) LLZO HQSE and b), d) Celgard.

FIG. 15 is a set of images showing disassembled Li—S battery after 0.5C cycling using electrolyte-infused a) LLZO HQSE and b) Celgard.

FIG. 16 is a set of images showing a) FESEM image and b) XRD pattern of liquid electrolyte-infused LLZO HQSE after cycling. * denotes the PTFE peak. Scale bar is 10 μm.

FIG. 17 is a set of graphs showing a) rate capability of LLZO HQSE and b) initial discharge-charge profiles of LLZO HQSE and commercial LLZO HQSE.

FIG. 18 is a set of FESEM images of a), b) commercial nano Al-doped LLZO a) powder and b) solid framework, and d) LLZO sheets solid framework, as well as c) Diassembled Li—S cell produced with commercial LLZO HQSE. Scale bar for a) is 1 μm and b) and d) is 10 μm.

FIG. 19 is a set of images showing disassembled Li—S batteries produced with a) LLZO HQSE, and b) Celgard after thermal stability test (first scenario); Li—S hybrid quasi-solid battery after thermal stability test (second scenario): c) before and d) after cell disassembly; and e) Li—S battery produced with Celgard after cell explosion from thermal stability test (second scenario).

### EXAMPLES

Non-limiting examples of the invention will be further described in greater detail by reference to specific Examples, which should not be construed as in any way limiting the scope of the invention.

### Example 1: Materials and Methods

Synthesis of LLZO sheets: LLZO sheets were synthesized via the “cupcake” method. 5.55 mmol sucrose (Biorad, Hercules, Calif., USA) was mixed with stoichiometric amounts of LiNO₃ (Merck) (5.14 mmol, with 10% in excess to account for possible Li loss during calcination), La(NO₃)₃.6H₂O (Sigma-Aldrich, St. Louis, Mo., USA) (2 mmol), and ZrO(NO₃)₂.xH₂O (Strem Chemicals, Newburyport, Mass., USA) (x was calculated based on the product's certificate of analysis supplied by the manufacturer) (1.334 mmol) in deionized water. The sol was heated at 250° C. for 3 hours, followed by 850° C. for at least 1 hour, then cooled to room temperature.

Preparation of LLZO HOSE solid framework: 100 mg of LLZO sheets was suspended in ethanol, to which 20 mg of polytetrafluoroethylene (PTFE) was added. The mixture was mixed well while evaporating the ethanol, leading to the formation of a gummy mass. The gummy mass was rolled into a membrane, which was cut into 16.2 mm-diameter discs. The discs were dried in an oven at 60° C.

Preparation of G/S and LiCoO₂ cathodes: Graphene (G)/S composite was synthesized according to a known method, with some modifications. Specifically, 200 mg of single layer graphene oxide (SLGO) was dispersed in a mixture of 100 mL of deionized water and 30 mL of absolute ethanol. 200 mg of sulfur, dissolved in 4 mL of CS₂, was added to the SLGO dispersion while stirring. The dispersion was kept stirring for 30 minutes, and then transferred into a 200-mL autoclave, and heated at 180° C. for 18 hours. The product was washed twice using ethanol and deionized water, and then freeze dried.

To prepare the G/S cathode, the G/S composite, acetylene black (AB), and vapor grown carbon fibers (VGCF) were mixed (at a weight ratio of 7:1.5:1.5) using PTFE as a binder using the membrane rolling method as described above. The membrane was cut into 12.7 mm-diameter discs. The discs were dried in an oven at 60° C.

LiCoO₂ cathode was prepared using commercial LiCoO₂, reduced graphene oxide, AB and VGCF at a weight ratio of 2.4:4:1:1 using the membrane rolling method as described above. The membrane was cut into 12.7 mm-diameter discs. The discs were dried in an oven at 60° C.

Materials Characterization: Morphological and structural characterizations were performed using field emission scanning electron microscope (FESEM) (JEOL, JSM-7400F) and TEM (FEI Tecnai F20), both fitted with EDX microanalyser (OXFORD). LLZO crystal structure was analyzed by XRD (Bruker D8 ADVANCE). S content in G/S composite was determined by thermal gravimetric analysis (TGA 55, TA Instruments).

Electrochemical Measurements: CR2032 coin cells were assembled inside an Ar-filled glove box with O₂ and H₂O levels of <1 ppm. Li metal was used as the anode, LLZO solid framework or commercial Celgard 2500 membrane were employed as the separator, and G/S or LiCoO₂ disc was used as the cathode. For G/S cathode, 1 M LiTFSI in dimethoxyethane (DME):1,3-dioxolane (DOL) (1:1 by volume) and 2 wt % LiNO₃ was used as liquid electrolyte at 35 to 40 μL/mg sulfur. For LiCoO₂ cathode, 1 M LiPF₆ in ethylene carbonate:diethyl carbonate (1:1 by volume) was used at 35 to 40 μL/mg LiCoO₂. CV (0.05 mV s⁻¹) and EIS (100 kHz-10 mHz, 10 mV amplitude) measurements were performed using AUTOLAB PGSTAT302N potentiostat. Ionic conductivity was calculated according to Equation 1:

σ=L/RA Eq. 1

where σ is conductivity in mS cm-1, L is thickness in cm, R is resistance in mΩ, and A is surface area in cm2. Li platting-stripping and galvanostatic discharge-charge measurements were conducted using LAND CT2001A battery cycler.

### Example 2: Synthesis and Structure of the LLZO Sheets

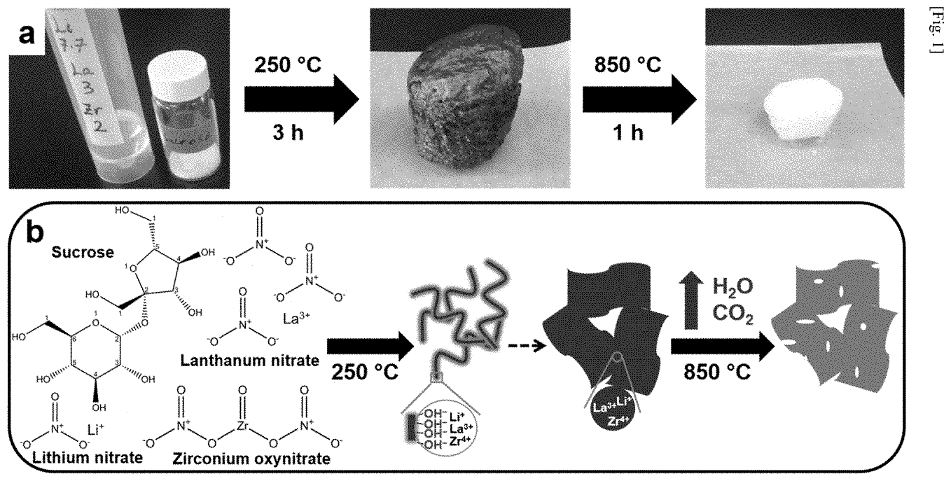

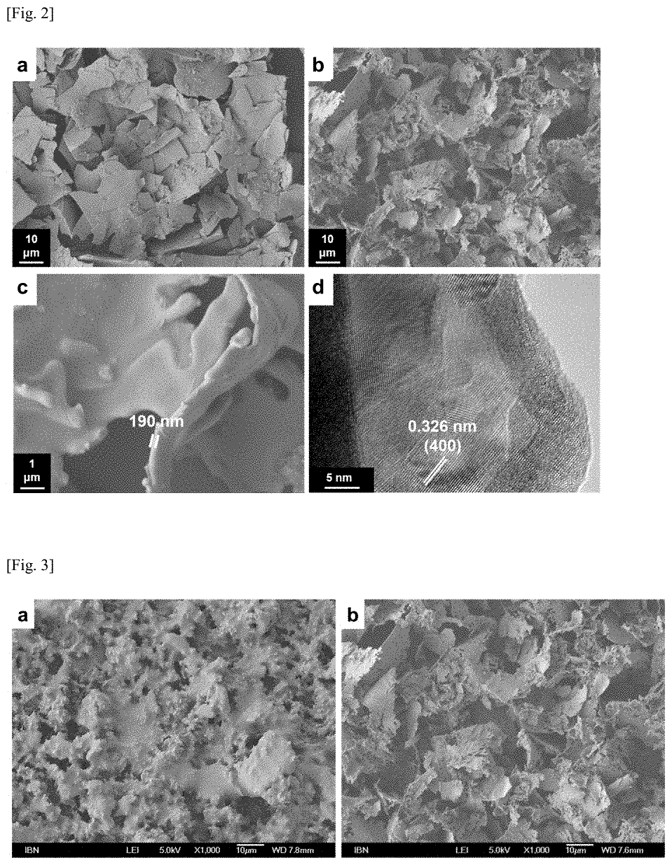

The synthesis process is depicted in FIGS. 1a and b. Metal nitrates and sucrose were dissolved in deionized water, forming a clear solution at a pH of 1.5. Sucrose acted as a polydentate ligand that bound the metal ions to form homogeneous metal ion-sucrose complex solution. When the solution was heated, sucrose underwent polymerization, followed by foaming due to thermal decomposition. Subsequently, a brown “cupcake” was formed whereby the internal structure was composed of large sheets (FIG. 2a). Upon further heating, the organic component was decomposed and oxidized as CO₂ and H₂O gases, while the homogeneously distributed metal ions reacted and crystallized into LLZO, which adopted the sheet morphology of the precursor (FIG. 2b). In the absence of sucrose, only bulk LLZO was obtained (FIGS. 3a and 3b), illustrating the critical role played by sucrose in sheet structure formation.

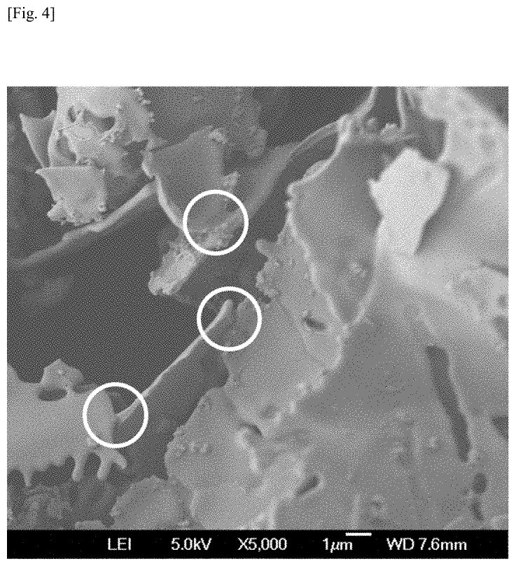

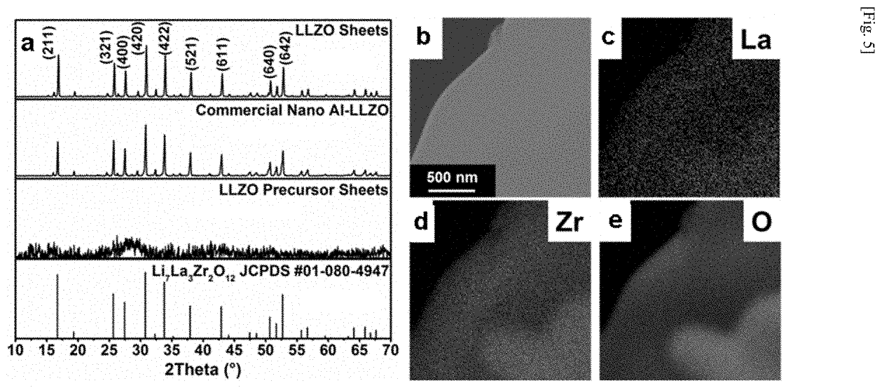

The sheets have micron-sized lateral dimensions, typically >10 μm, while their thickness is in the nanometre range, about 190 nm (FIG. 2c). Junctions, which were likely formed by coalescence during calcination, connected the sheets to each other (FIG. 4). The resulting continuous Li ion pathways would facilitate Li ion conductivity.

Powder X-ray diffraction (XRD) analysis (FIG. 5a) showed that the precursor sheets were amorphous. The LLZO sheets crystallized into the cubic phase (JCPDS #01-080-4947), and matched the cubic phase of commercial nano Al-doped LLZO particles in XRD pattern. The LLZO crystallite size was calculated to be 49.5 nm using the Scherrer equation (based on the highest intensity plane (420)). High-resolution transmission electron microscopy (TEM) imaging showed an interplanar d-spacing of 0.326 nm, which corresponded to (400) plane of cubic LLZO (FIG. 2d). Energy dispersive X-ray spectroscopy (EDX) showed the uniform distribution of elements over the sheets (FIGS. 5b to 5e).

### Example 3: Characterisation of LLZO HOSE

LLZO hybrid quasi-solid electrolyte (HOSE) was constructed using LLZO sheets as building blocks for the 3D solid framework, and lithium bis(trifluoromethanesulfonyl)imide (LiTFSI) in dimethoxyethane (DME)/1,3-dioxolane (DOL) with 2 wt % LiNO₃ as the liquid component. The 3D sheet-based framework readily imbibed the liquid electrolyte, and the HOSE showed fast Li ion diffusion, excellent compatibility with Li metal, and high mechanical and anodic stability.

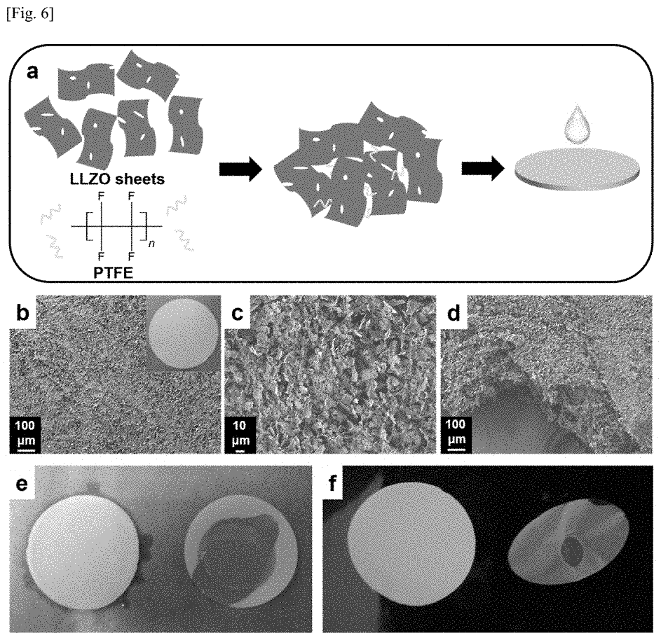

FIG. 6a presents the schematic of LLZO HOSE preparation. The interconnected LLZO sheets were bound together using polytetrafluoro-ethylene (PTFE), and then processed into approximately 250 to 350 μm-thick discs (FIG. 6b: inset), which were imbibed with the liquid electrolyte. The LLZO sheets were assembled together as a 3D framework with a porous nature (FIGS. 6b to 6d). The LLZO framework could easily imbibe the liquid electrolyte, providing superior electrolyte infiltration (FIG. 6e, left), as compared to commercial Celgard 2500 membrane having a typical pore size of 64 nm. (FIG. 6e, right). LLZO HQSE displayed excellent thermal stability, with no shrinkage or morphological change, after exposure to a temperature of 150° C. for 10 minutes (FIG. 6f, left). This was due to the high thermal stability of LLZO and PTFE binder. In contrast, the Celgard membrane melted under the testing conditions, showing severe shrinkage and disfigurement (FIG. 6f, right).

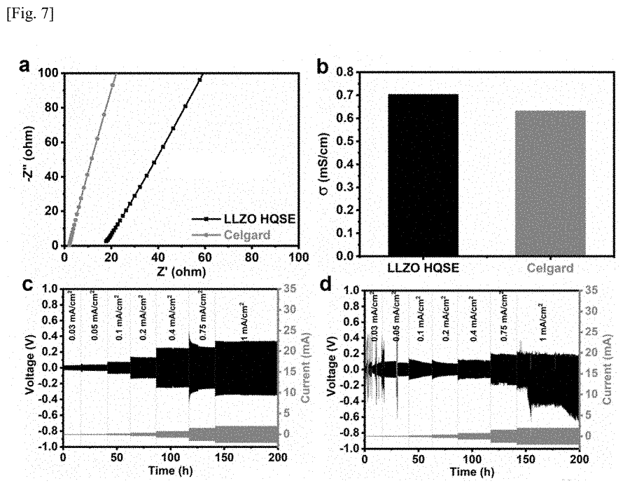

Ionic conductivity of LLZO HQSE was investigated via electrochemical impedance spectroscopy (EIS) at room temperature. The Nyquist plot (FIG. 7a) showed a straight line, whose intercept with the real axis indicated bulk resistance. No semi-circle was observed, indicating the absence of grain boundary resistance, which was attributed to the infiltration of the liquid electrolyte within the LLZO framework. The ionic conductivity of LLZO HQSE was calculated to be 0.7 mS/cm, which was comparable to that obtained using Celgard separator (FIG. 7b), showing the suitability of LLZO HQSE for utilization in lithium batteries.

Stability of LLZO HQSE against Li metal was studied by galvanostatic cycling of a symmetric Li/LLZO HQSE/Li cell for 200 hours at increasing current densities (FIG. 7c). LLZO HQSE displayed smooth cycling with no significant voltage fluctuation. In contrast, the Celgard separator displayed significant instability during initial cycling, and major hysteresis at the high current density of 1 mA cm⁻² (FIG. 7d). These results demonstrated that the LLZO HQSE has a more stable interface with Li metal, resulting in uniform Li deposition and mitigating dendrite growth.

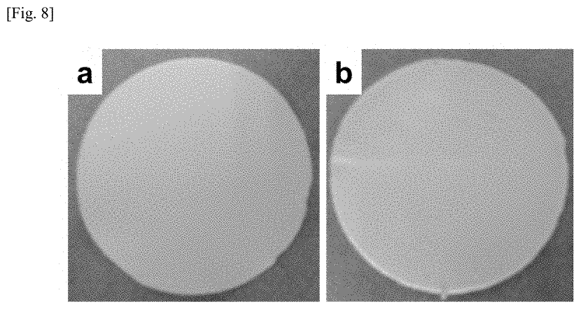

LLZO HQSE also exhibited good mechanical stability; its non-rigid structure could tolerate processing during preparation and cell assembly/disassembly, with no cracking or disintegration as shown in FIG. 8, where it can be seen that there is no major change in the LLZO HQSE as prepared (FIG. 8a) and after EIS testing and coin cell disassembly (FIG. 8b).

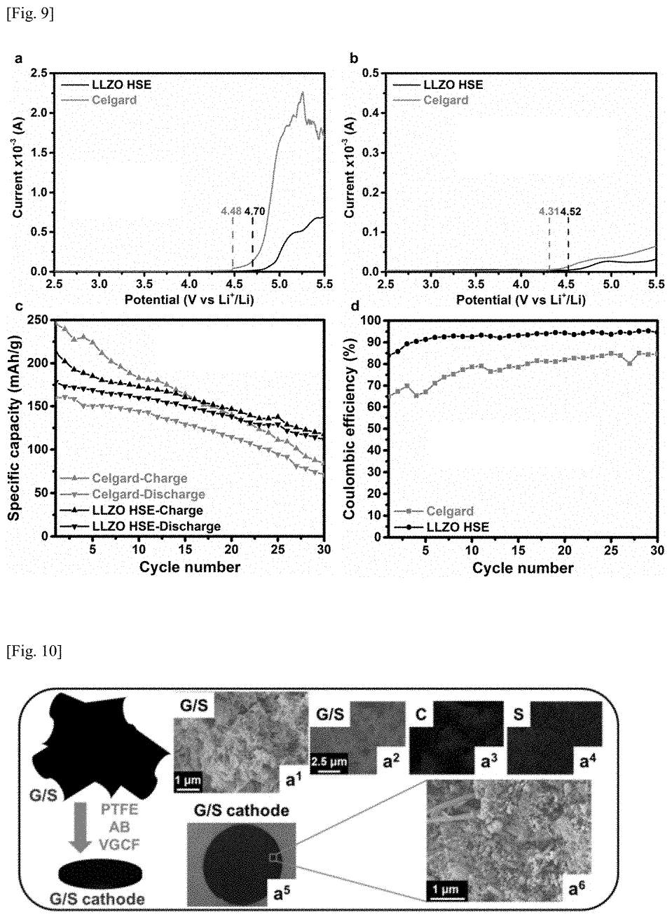

Moreover, LLZO HQSE showed enhanced anodic stability (FIGS. 9a and 9b), rendering it a promising candidate for high-voltage cathode. LiCoO₂ was used as a model cathode operating at relatively high voltage (3-4.3 V vs. Li⁺/Li). LLZO HQSE showed a better cycling stability and Coulombic efficiency than Celgard (FIGS. 9c and 9d). Specifically, it was found that the LLZO solid framework could stabilize the liquid electrolyte at high voltage. The LLZO HQSE was stable until 4.70 V and 4.52 V vs. Li⁺/Li, as compared to 4.48 V and 4.31 V in the case of Celgard membrane, using LiTFSI in DME/DOL and LiPF₆ in ethylene carbonate/diethyl carbonate electrolytes, respectively. The higher anodic stability imparted by the LLZO solid framework may be due to its interaction with the liquid electrolyte, which improved its oxidation resistance.

### Example 4: LLZO HOSE In A Li—S Battery

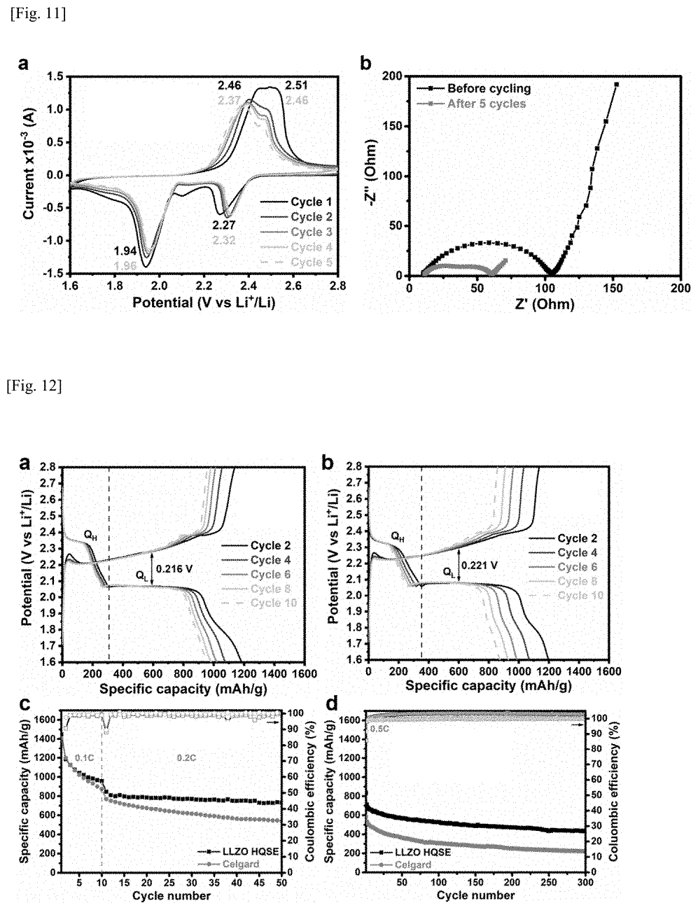

LLZO HQSE was applied in Li—S hybrid quasi-solid system, displaying high electrochemical reversibility and enhanced battery performance. A current collector-free cathode was prepared using graphene (G)/S composite, carbon additives and PTFE binder. The carbon additives provided the necessary electrical links within the G/S composite, while PTFE enabled the processing into a flexible free-standing electrode (FIG. 10). Cyclic voltammetry (CV) and electrochemical impedance spectroscopy (EIS) of Li—S hybrid quasi-solid battery showed high electrochemical reversibility and reduced polarization over cycling (FIGS. 11a and 11b), which indicated good electrode/electrolyte contact.

The CV showed the typical two cathodic peaks at 2.27 V and 1.94 V, which are attributed to reduction of sulfur (S₈) to long-chain (Li₂Sₙ, 4≤n≤8), and short-chain (Li₂Sₙ, 1≤n<4) PS, respectively, as well as two overlapping anodic peaks at 2.46 and 2.51 V, which represent the reverse oxidation back to long-chain PS and S₈ (FIG. 11a). The overlapping of the CV curves after the first cycle showed the high electrochemical reversibility, while the positive and negative cathodic and anodic shifts, respectively, indicated reduced polarization and resistance over cycling. The reduced resistance over cycling was confirmed by EIS (FIG. 11b), whereby the diameter of the semicircle in middle-high frequency region, attributed to charge-transfer resistance, decreased significantly after five cycles. This may be explained by an activation process involving active material redistribution.

Li—S battery with LLZO HQSE has an initial capacity of 1448.3 mAh/g at 0.1C, which was higher than the 1405.0 mAh/g achieved with Celgard membrane (FIG. 12c). After 10 cycles, their capacities reached 957.2 and 874.2 mAh/g, respectively, with capacity fade/cycle of 2.13% and 3%, respectively, after the first cycle. The discharge-charge profiles were studied to gain further insight into their performance. LLZO HQSE displayed two distinct discharge plateaus and two overlapping charge plateaus (FIG. 12a), which was consistent with the CV profile, and similar to that displayed by Celgard membrane (FIG. 12b). However, LLZO HQSE showed a lower polarization of 0.216 V, as compared to 0.221 V shown by Celgard, which indicated enhanced redox kinetics and better energy efficiency, further confirming the minimized electrode/electrolyte interfacial resistance due to the good contact in the former.

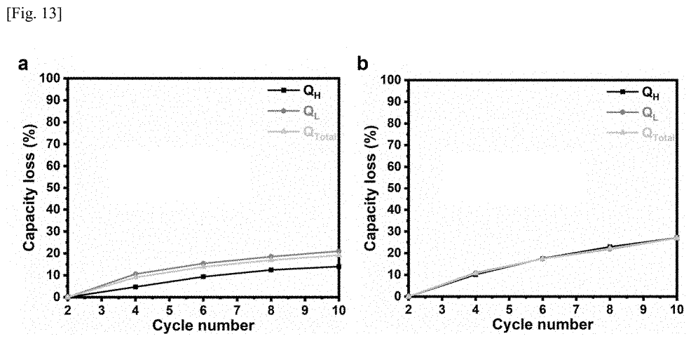

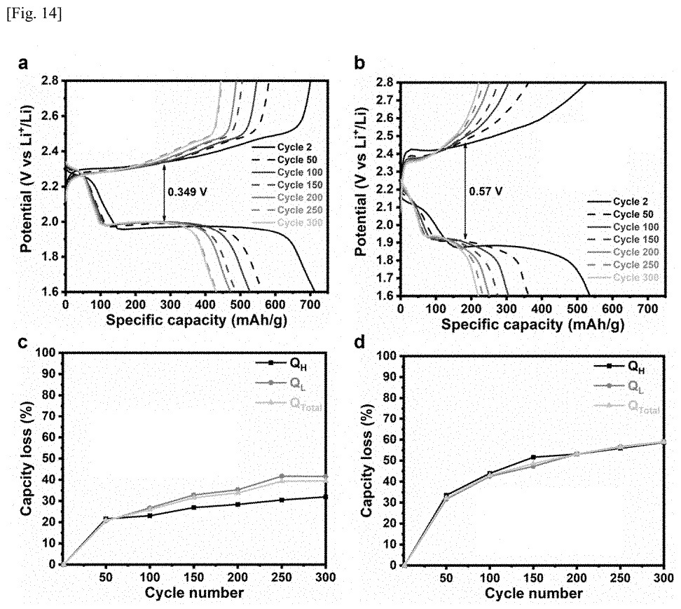

In addition, the upper plateau capacity (Q_{H}) loss was ˜50% less with LLZO HQSE (FIG. 13a), as compared to Celgard (FIG. 13b). The significantly reduced Q_{H} loss by LLZO HQSE indicated its effective role in mitigating PS diffusion, resulting in less active material loss, which reduced the lower plateau capacity (Q_{L}) and total capacity (Q_{T}) loss. PS shuttling control by LLZO is known, and is attributed to its chemical affinity to soluble PS, and the physical barrier introduced by the LLZO framework. On the other hand, Celgard displayed high Q_{H} loss due to its inability to control PS shuttling, which resulted in increased Q_{L} and Q_{T} fading.

The improved performance of LLZO HQSE could be better observed with prolonged cycling. LLZO HQSE retained 730.7 mAh/g when cycled for another 40 cycles at 0.2C, with capacity retention (after the first cycle) of 90.2% and capacity fade/cycle (after the first cycle) of 0.25%, as compared to 542.9 mAh/g, 72.3% and 0.71% shown by Celgard, respectively (FIG. 12c). At 0.5C, LLZO and Celgard have initial capacities of 834.5 and 586.8 mAh/g, which decreased to 431.5 and 220.7 mAh/g after 300 cycles, with capacity retention (after the first cycle) of 60.5% and 41.1%, and capacity fade/cycle (after the first cycle) of 0.13% and 0.2%, respectively (FIG. 12d).

Analysis of the discharge-charge profiles at 0.5C agreed with that of 0.1C profiles. A smaller polarization of 0.349 V was observed with LLZO HQSE, as compared to 0.57 V with Celgard (FIGS. 14a and 14b), indicating better reaction kinetics. Interestingly, LLZO HQSE also showed ˜50% less Q_{H} loss, as compared to Celgard, which resulted in lower Q_{L} and Q_{T} loss (SI FIGS. 14c and 14d), leading to better capacity retention. This confirmed the earlier observation about the role of LLZO in controlling PS shuttling.

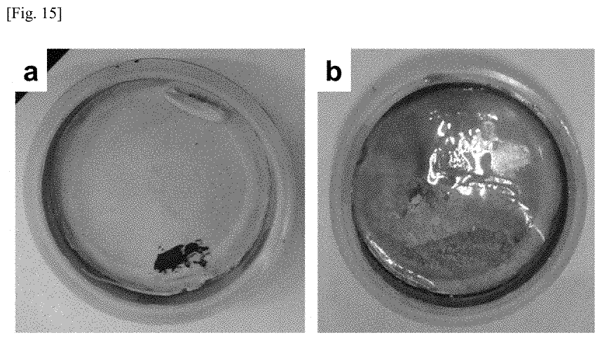

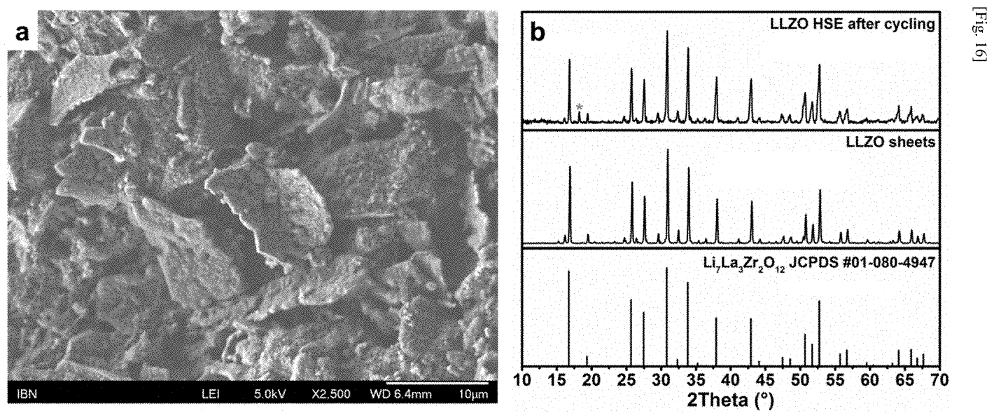

The cycled LLZO HQSE appeared as an orange-colored semi-solid disc with no separate liquid electrolyte observed (FIG. 15a). This showed that the liquid electrolyte was completely imbibed within the LLZO solid framework, and that the battery operated in a hybrid quasi-solid state with no risk of electrolyte leakage. The orange color may be due to the PS anchored to the LLZO sheets. In contrast, the battery operated using Celgard showed a brown-colored liquid (FIG. 15b), implying substantial PS diffusion, which may explain its inferior performance.

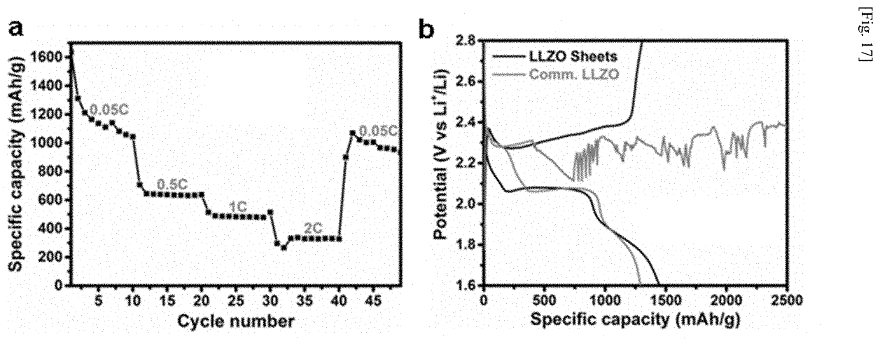

Interestingly, the sheet-like morphology of the cycled LLZO and its cubic crystal structure were stable after cycling (FIGS. 16a and 16b), indicating its stability against the liquid electrolyte and PS. LLZO HQSE was further tested at higher current densities to investigate its rate capability, which is the main limitation for Li—S hybrid quasi-solid systems. LLZO HQSE showed capacities of 1635.0, 707.1, 514.5 and 331.1 mAh V at 0.05C, 0.5C, 10 and 2C, respectively, and could recover to 1068.7 mAh/g at 0.05C (FIGS. 17a and 17b). The Li—S hybrid quasi-solid battery performance was among the best reported in the literature (Table 1).

TABLE 1
Comparison of the performance of Li—S hybrid quasi-
solid battery with previously reported systems.

| | | Current | Initial | | Final |
|---|---|---|---|---|---|
| | S loading | density | capacity | No. of | capacity |
| HQSE solid component | (mg cm⁻²) | (mA cm⁻²) | (mAh g⁻¹) | cycles | (mAh g⁻¹) |
| Li₇La₃Zr₂O₁₂ | 1.2 | 0.2-0.4 | 1448.3 | 10-40 | 730.7 |
| (inventive example) | 1.3 | 1.1 | 834.5 | 300 | 431.5 |
| | 1.5 | 2.5 | 514.5 | 10^{a} | 514 |
| Li_{6.4}La₃Zr_{1.4}Ta_{0.6}O₁₂—MgO | 1 | 0.3 | 1100 | 200 | 685 |
| Li_{6.45}Ca_{0.05}La_{2.95}Ta_{0.6}Zr_{1.4}O₁₂ | 0.71 | 0.2 | 786 | 50 | 326.8 |
| Li_{6.4}La₃Zr_{1.4}Ta_{0.6}O₁₂ | 2.3 | 0.04 | 1100 | 30 | 706 |
| | | 0.4 | 855 | 40 | 560 |
| Li_{6.4}La₃Zr_{1.4}Ta_{0.6}O₁₂ | 1 | 0.2-0.3 | 1366 | 6-44 | 841 |
| | | 0.8 | 649 | 500 | 537 |
| | | 1.7 | 463 | 31^{a} | N/A |
| Li₁₊ₓAlₓTi₂₋ₓ(PO₄)₃ | 3 | 0.2 | ~975 | 150 | ~800 |
| | | 0.5 | 750 | N/A | N/A |
| LiCoO₂ | 5.5 | 0.46 | ~700 | 200 | ~460 |
| Li₇La₃Zr₂O₁₂ | 1.2 | 0.2 | ~1000 | N/A | N/A |
| | | 1 | 550 | 50 | ~400 |
| Li₇La_{2.75}Ca_{0.25}Zr_{1.75}—Nb_{0.25}O₁₂ | 7.5 | 0.2 | 645 | 30 | ~500 |
| Li_{1.5}Al_{0.5}Ge_{1.5}(PO₄)₃^{b} | 1 | 0.2 | 1253 | 50 | 622 |
| Li_{1.5}Al_{0.5}Ge_{1.5}(PO₄)₃ | 2.1 | 0.2 | 1128.2 | 50 | 770.1 |
| Li_{1.3}Al_{0.3}Ti_{1.7}(PO₄)₃ | N/A | N/A (0.1 C) | 978 | 50 | ~750 |
| Li_{1.3}Al_{0.3}Ti_{1.7}(PO₄)₃ | 1.7 | 0.3 | ~1200 | 300 | ~300 |
| Li_{1.5}Al_{0.5}Ge_{1.5}(PO₄)₃ | N/A | N/A (0.2 C) | 1386 | 40 | 720 |

^{a}Rate study.
^{b}Data obtained using DME/DOL electrolyte solvent.

It should be noted that none of the comparative examples listed above that are garnet-type oxides were used in the form of a powder comprising a plurality of sheet structures.

The higher performance of the inventive example may be attributed to the intricate LLZO HQSE design. Unlike the commonly used dense solid pellets/layers, the LLZO sheet structures form a non-rigid 3D solid framework that is infused with liquid electrolyte. This design allows battery operation in a hybrid quasi-solid state, while ensuring high Li ion conductivity and low interfacial resistance, thus achieving high capacity, cycling stability, and rate capability. In addition, PS shuttling was significantly reduced by the LLZO sheets and the solid framework's microstructure, which further improved battery performance.

### Example 5: Comparison with Commercial LLZO

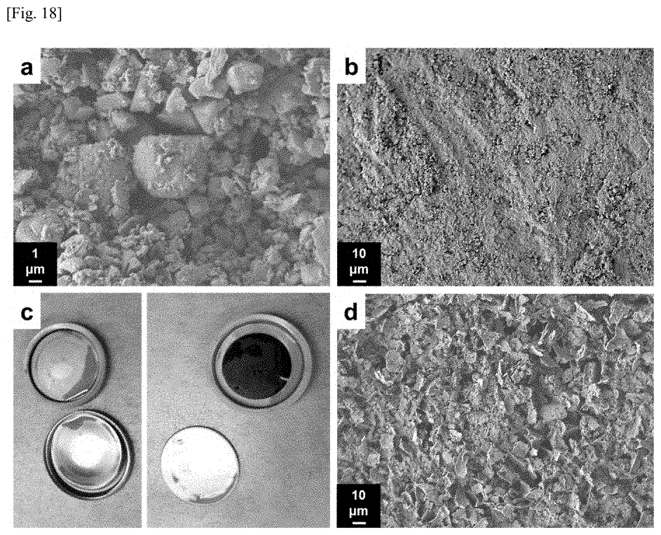

In order to validate the significance of the 3D sheet-based framework structure for battery performance, commercial nano Al-doped cubic LLZO was used as a control. Commercial LLZO showed bulky particles (FIG. 18a) that comprised nanocrystallites of 46.4 nm, as calculated by Scherrer equation using the highest intensity plane (420) (FIG. 5a). Commercial LLZO framework showed a very compact and dense structure (FIG. 18b), as compared to LLZO sheets framework (FIG. 18d), due to the high packing density of the commercial LLZO particles.

The commercial LLZO has an irregular morphology, mostly showing agglomerated bulky particles (FIG. 18a). At 0.1C, commercial LLZO HQSE showed an initial discharge capacity of 1291.2 mAh g⁻¹ (FIG. 18b), which was slightly less than that achieved by LLZO HQSE produced according to this disclosure. However, the commercial LLZO HQSE was not able to follow up with the charge process, displaying a highly fluctuating charge voltage. This phenomenon has been reported previously, and was attributed to the failure to conduct Li ions. Such failure may be explained by the very dense and compact structure of commercial LLZO HQSE (FIG. 18b), which may have been completely blocked by the interphase layer formed on the surface of LLZO particles during the initial discharge. The large volume of liquid electrolyte observed upon disassembling the cell (FIG. 18c) also revealed the inability of the commercial LLZO HQSE to imbibe liquid electrolyte due to its compact, non-porous structure. These results illustrated the significance of the LLZO's sheet morphology and the LLZO HQSE's porous architecture for optimal battery operation.

One of the main advantages of hybrid quasi-solid systems is improved battery safety. Therefore, thermal stability experiments were conducted to evaluate the battery safety profile of LLZO HQSE. Li—S batteries were exposed to two scenarios of extreme temperature conditions. In the first scenario, the cells were heated gradually, initially at 150° C. for 30 min, and then at 180° C. and 210° C. for 10 minutes each. In the second scenario, the cells were exposed to a sudden high temperature of 200° C. for 5 minutes.

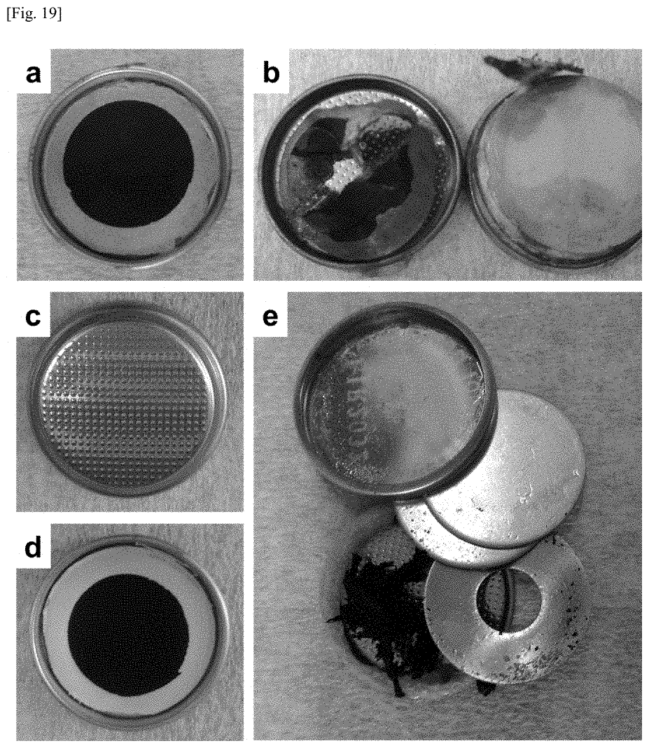

LLZO HQSE was stable in both scenarios (FIG. 19a, 19c, 19d), while Celgard showed very poor stability profile. In the first scenario, the Celgard membrane was damaged, leading to full contact between both electrodes (FIG. 19b). In the second scenario, the cell exploded violently (FIG. 19e). These results demonstrated the superior safety profile of LLZO HQSE-based Li—S battery, and highlighted the potential role of hybrid quasi-solid electrolytes in substantially improving the safety profile of lithium batteries.

### INDUSTRIAL APPLICABILITY

The material as disclosed herein may be incorporated into a hybrid quasi-solid electrolyte framework, which may in turn by used to form a hybrid quasi-solid electrolyte for use in an electrochemical cell. The method for forming the material may be a one-step sol-gel process, facilitating facile and cost-effective generation of sheet structures. The hybrid quasi-solid membrane may be used as a quasi-solid electrolyte for safer lithium rechargeable batteries, such as Li—Si, Li-ion and Li-air batteries.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A material comprising a garnet-type oxide in the form of a powder comprising a plurality of sheet structures.

2. The material according to claim 1, wherein the sheet structures are interconnected with each other.

3. The material according to claim 1, wherein the material comprises a solid mixture of at least lithium and oxygen and optionally an element selected from the group consisting of magnesium, aluminum, silicon, calcium, scandium, vanadium, manganese, iron, nickel, gallium, germanium, strontium, yttrium, zirconium, niobium, barium, tantalum, lanthanum, cerium, neodymium, samarium, europium, gadolinium, terbium and any mixture thereof or is further doped with one or more elements selected from the group consisting of hydrogen, beryllium, boron, carbon, sodium, phosphorous, sulfur, chlorine, potassium, titanium, chromium, cobalt, copper, zinc, arsenic, selenium, bromine, rubidium, molybdenum, technetium, ruthenium, rhodium, palladium, silver, cadmium, indium, tin, antimony, tellurium, iodine, cesium, hafnium, tungsten, iridium, platinum, gold, mercury, thallium, lead, bismuth, and any mixture thereof.

4.-5. (canceled)

6. The material according to claim 1, wherein the sheet structures have a lateral dimension of greater than 1 μm and a thickness in a range of about 100 nm to about 250 nm or the sheet structures are crystalline.

7. (canceled)

8. A method for forming the material according to claim 1, the method comprising the step of:
mixing a plurality of precursors of a garnet-type oxide in an aqueous solvent in the presence of a sugar to form a sol, and heating the sol.

9. The method according to claim 8, wherein the method is a sol-gel method.

10. The method according to claim 8, wherein the precursors are selected from at least a lithium salt and oxygen or a compound comprising oxygen and optionally a compound comprising an element selected from the group consisting of magnesium, aluminum, silicon, calcium, scandium, vanadium, manganese, iron, nickel, gallium, germanium, strontium, yttrium, zirconium, niobium, barium, tantalum, lanthanum, cerium, neodymium, samarium, europium, gadolinium, terbium, and any mixture thereof or further comprises the step of incorporating a dopant into the material, the dopant being one or more elements selected from the group consisting of hydrogen, beryllium, boron, carbon, sodium, phosphorous, sulfur, chlorine, potassium, titanium, chromium, cobalt, copper, zinc, arsenic, selenium, bromine, rubidium, molybdenum, technetium, ruthenium, rhodium, palladium, silver, cadmium, indium, tin, antimony, tellurium, iodine, cesium, hafnium, tungsten, iridium, platinum, gold, mercury, thallium, lead, bismuth, and any mixture thereof.

11.-13. (canceled)

14. The method according to claim 8, wherein the sugar is a monosaccharide, a disaccharide, an oligosaccharide, or any mixture thereof.

15. The method according to claim 9, wherein the sol gel has a pH in a range of about 1 to about 2.

16. The method according claim 8, wherein the heating step comprises a first heating step and a second heating step, wherein the first heating step is performed at a temperature in a range of about 150° C. to about 500° C., and a duration in a range of 0.5 hours to 5 hours, or more than 5 hours, and the second heating step is performed at a temperature in a range of about 600° C. to about 1500° C., and a duration in a range of about 30 minutes to about 10 hours, or more than 10 hours.

17. (canceled)

18. A hybrid quasi-solid electrolyte framework comprising the material according to claim 3 and a polymer.

19. The hybrid quasi-solid electrolyte framework of claim 18, wherein the polymer is selected from the group consisting of polytetrafluoroethylene (PTFE), polyvinylidene fluoride, polyethylene oxide, sodium alginate, sodium carboxymethyl cellulose, polyacrylic acid, poly(acrylonitrile-methyl methacrylate), styrene butadiene rubber/carboxy methyl cellulose (SBR/CMC), a copolymer comprising acrylamide, lithium carboxylate and acrylonitrile, and any mixture thereof.

20. The hybrid quasi-solid electrolyte framework of claim 18, wherein the ratio between the hybrid quasi-solid electrolyte framework:polymer is in a range of about 20:1 to about 2:1 by weight.

21. (canceled)

22. The hybrid quasi-solid electrolyte framework according to claim 18, wherein the framework is porous.

23. A method for forming the hybrid quasi-solid electrolyte framework according to claim 18, the method comprising the step of mixing said material with a polymer to form a framework mixture.

24.-25. (canceled)

26. A hybrid quasi-solid electrolyte comprising the hybrid quasi-solid electrolyte framework of claim 18 and an electrolyte dissolved in an electrolyte solvent.

27. The hybrid quasi-solid electrolyte according to claim 26, wherein the electrolyte is present in the electrolyte solvent at a concentration in a range of about 0.25 M to about 10 M.

28. The hybrid quasi-solid electrolyte according to claim 26, wherein the electrolyte comprises a lithium compound.

29. The hybrid quasi-solid electrolyte according to claim 26, wherein the electrolyte solvent is selected from the group consisting of ether, carbonate, and any mixture thereof.

30. (canceled)

31. The hybrid quasi-solid electrolyte according to claim 26, wherein the electrolyte further comprises an electrolyte additive.

32. A method for preparing the hybrid quasi-solid electrolyte according to claim 26, the method comprising the step of contacting the hybrid quasi-solid electrolyte framework with the electrolyte.

33. An electrochemical cell comprising the hybrid quasi-solid electrolyte of claim 26, a cathode, and an anode.

34. The electrochemical cell according to claim 33, wherein the cathode is selected from the group consisting of a sulfur cathode, a sulfur carbon/ceramic cathode, and a metal-based cathode.

35.-36. (canceled)

37. The electrochemical cell according to claim 33, wherein the anode comprises a material selected from the group consisting of lithium metal, graphite, hard carbon, silicon, tin, silicon/C composite, tin/C composite, and any mixture thereof.

38. A method of manufacturing an electrochemical cell according to claim 33, the method comprising the step of contacting the hybrid quasi-solid electrolyte with the cathode and the anode.

39. (canceled)
